(19) United States
(12) Patent Application Publication
(10) Pub. No.: US 2025/0371188 A1
(43) Pub. Date: Dec. 4, 2025

(54) CONFIGURING INSTANCES FOR DATA OBSERVABILITY AND ACCESS

(71) Applicant: ServiceNow, Inc., Santa Clara, CA (US)

(72) Inventors: Jiayin Song, Seattle, WA (US); Shicheng Zhang, San Francisco, CA (US); Shu-Wei Hsu, San Francisco, CA (US); Hao Wang, Union City, CA (US)

(21) Appl. No.: 18/680,789

(22) Filed: May 31, 2024

(51) Int. Cl. G06F 21/62; G06F 16/22

(52) U.S. Cl. CPC G06F 21/6227; G06F 16/245; G06F 21/604; G06F 16/221

(57) ABSTRACT

Systems and methods to establish a time window in which access to a table in a database is monitored, identify every source caller and the information accessed by the caller during the time window, and determine a module access policy (MAP) based on the monitored information to enable column-level encryption. The system may then permit or deny access to information in a column-level encrypted database according to the MAP.

### TECHNICAL FIELD

The present disclosure relates to observing data access from a caller source and generating an access policy to enable future data access from the same caller source.

### BACKGROUND

Databases can contain large amounts of private data, including personal information or corporate trade secrets. Thus, these databases are usually encrypted. When a caller source (e.g., an entity requesting access, such as a human user or automation software) attempts to access the database for information, the caller can be granted access on a database level, table level, or column level. However, when the caller is granted higher level access to a relatively large dataset (e.g., entire tables), privacy concerns can arise, even if only a small portion of database information is accessed.

### SUMMARY

One aspect of the disclosure includes a method for identifying data access in a data table and generating an access policy to the data table. The method may include monitoring, during a monitoring period, access of a plurality of columns of a data table by a first user and a second user. The method may further include generating, based on the monitoring, a log indicating, for each column of the plurality of columns of the data table, a first number of times the respective column was accessed by the first user and a second number of times the respective column was accessed by the second user. The method may further include generating, based on the log and a first profile corresponding to the first user, a first access policy controlling access to each column of the plurality of columns of the data table by the first user. The method may further include generating, based on the log and a second profile corresponding to the second user, a second access policy controlling access to each column of the plurality of columns of the data table by the second user. The method may further include applying the first access policy and the second access policy.

Implementations of the disclosure may include one or more of the following features. The method may include, wherein monitoring access of the plurality of columns of the data table by the first user and the second user comprises, for each column of the plurality of columns, counting the first number of times the respective column is accessed by the first user and counting the second number of times the respective column is accessed by the second user. The method may indicate that the first access policy is different from the second access policy. The method may further indicate the first access policy is the same as the second access policy. The method may further include monitoring, during a second monitoring period, a change in access of the plurality of columns of the data table by the first user and the second user, generating, based on the second monitoring period, a second log, and modifying, based on the second log, the first access policy and the second access policy. The method may additionally indicate that a duration of the monitoring period is predefined according to a data observability configuration setting. The method may further indicate the log comprises a rotated table. The method may further include decrypting one or more encrypted columns of the data table requested by the first user based on the applied first access policy. The method may further include decrypting one or more encrypted columns of the data table requested by the second user based on the applied second access policy. The method may further include returning an error message to the first user when the first access policy does not permit access to the plurality of columns in the data table.

Another aspect of the disclosure includes a system comprising one or more processors and a memory including computer-executable instructions. The one or more processors, when executing the computer-executable instructions, may cause the system to monitor, during a monitoring period, access of a plurality of columns of a data table by a first user and a second user. The one or more processors may further cause the system to generate, based on the monitoring, a log indicating, for each column of the plurality of columns of the data table, a first number of times the respective column was accessed by the first user and a second number of times the respective column was accessed by the second user. The one or more processors may further cause the system to generate, based on the log and a first profile corresponding to the first user, a first access policy controlling access to each column of the plurality of columns of the data table by the first user. The one or more processors may further cause the system to generate, based on the log and a second profile corresponding to the second user, a second access policy controlling access to each column of the plurality of columns of the data table by the second user. The one or more processors may further cause the system to apply the first access policy and the second access policy.

Implementations of the disclosure may include one or more of the following features. The one or more processors may further cause the system to include wherein monitoring access of the plurality of columns of the data table by the first user and the second user comprises, for each column of the plurality of columns, counting the first number of times the respective column is accessed by the first user and counting the second number of times the respective column is accessed by the second user. The one or more processors may further cause the system to indicate that the first access policy is different from the second access policy. The one or more processors may further cause the system to indicate the first access policy is the same as the second access policy. The one or more processors may further cause the system to monitor, during a second monitoring period, a change in access of the plurality of columns of the data table by the first user and the second user, generate, based on the second monitoring period, a second log, and modify, based on the second log, the first access policy and the second access policy. The one or more processors may further cause the system to indicate that a duration of the monitoring period is predefined according to a data observability configuration setting. The one or more processors may further cause the system to indicate the log comprises a rotated table. The one or more processors may further cause the system to decrypt one or more encrypted columns of the data table requested by the first user based on the applied first access policy. The one or more processors may further cause the system to decrypt one or more encrypted columns of the data table requested by the second user based on the applied second access policy. The one or more processors may further cause the system to return an error message to the first user when the first access policy does not permit access to the plurality of columns in the data table.

Another aspect of the disclosure includes a non-transitory computer-readable storage medium having stored thereon executable instructions that are executable by one or more processors of a computer system. The computer-readable storage medium may include instructions to monitor, during a monitoring period, access of a plurality of columns of a data table by a first user and a second user. The computer-readable storage medium may further include instructions to generate, based on the monitoring, a log indicating, for each column of the plurality of columns of the data table, a first number of times the respective column was accessed by the first user and a second number of times the respective column was accessed by the second user. The computer-readable storage medium may further include instructions to generate, based on the log and a first profile corresponding to the first user, a first access policy controlling access to each column of the plurality of columns of the data table by the first user. The computer-readable storage medium may further include instructions to generate, based on the log and a second profile corresponding to the second user, a second access policy controlling access to each column of the plurality of columns of the data table by the second user. The computer-readable storage medium may further include instructions to apply the first access policy and the second access policy.

Implementations of the disclosure may additionally include one or more of the following features. The computer-readable storage medium may further include instructions that cause the computer system to indicate wherein to monitor access of the plurality of columns of the data table by the first user and the second user comprises, for each column of the plurality of columns, counting the first number of times the respective column is accessed by the first user and counting the second number of times the respective column is accessed by the second user. The computer-readable storage medium may further include instructions that cause the computer system to indicate that the first access policy is different from the second access policy. The computer-readable storage medium may further include instructions that cause the computer system to indicate the first access policy is the same as the second access policy. The computer-readable storage medium may further include instructions that cause the computer system to monitor, during a second monitoring period, a change in access of the plurality of columns of the data table by the first user and the second user, generate, based on the second monitoring period, a second log, and modify, based on the second log, the first access policy and the second access policy. The computer-readable storage medium may further include instructions that cause the computer system to indicate that a duration of the monitoring period is predefined according to a data observability configuration setting. The computer-readable storage medium may further include instructions that cause the computer system to indicate the log comprises a rotated table. The computer-readable storage medium may further include instructions that cause the computer system to decrypt one or more encrypted columns of the data table requested by the first user based on the applied first access policy. The computer-readable storage medium may further include instructions that cause the computer system to decrypt one or more encrypted columns of the data table requested by the second user based on the applied second access policy. The computer-readable storage medium may further include instructions that cause the computer system to return an error message to the first user when the first access policy does not permit access to the plurality of columns in the data table.

### BRIEF DESCRIPTION OF THE DRAWINGS

Various embodiments in accordance with the present disclosure will be described with reference to the drawings, in which:

FIG. 1 illustrates a data observability system, according to at least one embodiment;

FIG. 2 illustrates a data access process, according to at least one embodiment;

FIG. 3 illustrates a data observability process, according to at least one embodiment;

FIG. 4 illustrates an example data observability configuration and table, according to at least one embodiment;

FIG. 5 illustrates a module access policy generation process, according to at least one embodiment; and

FIG. 6 illustrates a system in which various embodiments can be implemented.

### DETAILED DESCRIPTION

In preceding and following descriptions, various techniques are described. For purposes of explanation, specific configurations and details are set forth in order to provide a thorough understanding of possible ways of implementing techniques. However, it will also be apparent that techniques described below may be practiced in different configurations without specific details. Furthermore, well-known features may be omitted or simplified to avoid obscuring techniques being described.

In database management, it can be advantageous to limit what information a caller source (e.g., an entity requesting access to at least a portion of a database, such as a human user, a software process, a role, a scope, etc.) may access to preserve information privacy. Column-level encryption (e.g., limiting the entity to access only the columns with the information it needs) is an advantageous method for data privacy, but this granular level of encryption means that every possible caller needs to be preset with a Module Access Policy (MAP) that explicitly outlines what information it is allowed to access. When tables are extremely complex with multiple entities from many different sources (e.g., system tables), it becomes difficult to identify and create a MAP for each entity. While there is a way to see which entity has accessed a given table, there is no current way to track what specific information the entity requires access to at any given time. In these cases, column-level encryption can cause database dropouts or crashes when a critical service cannot access data it needs because a MAP was not properly created for it.

Various implementations disclosed herein include establishing a time window in which table access is monitored, identifying every entity and the information accessed by the entity during the time window, and then determining a module access policy (MAP) based on the monitored information to enable column-level encryption. In at least one embodiment, an admin of a database instance presets a data observability configuration to establish a time period in which all accesses to a predetermined column of a predetermined table are tracked and logged. At the conclusion of the time period, all entities that accessed the column can be identified and output to a user as a data observability tracking log. In at least one embodiment, a MAP for each entity can be created using the data observability tracking log. This way, column-level encryption can be enabled on even the most complex tables because all of the entities that require access have been given a proper MAP to access exactly the information each entity needs, allowing for instance-level control.

In at least one embodiment, the data observability tracking log is implemented as an additional table in the database volume, with time periods preset by a user in order to prevent the tracking log from becoming too unwieldy. In at least one embodiment, because the tracking log is generally expected to be a large table, the tracking log is implemented as a rotated table (i.e., a table that overwrites oldest data with new data during each rotation) to ensure that the table is controlled in size. Other implementations include establishing a summary table that includes specific observed results from the tracking information that can be maintained and accessed without risk of being overwritten.

The implementations described herein provide many advantages over known techniques. For example, implementations herein provide for the automatic creation of a MAP based on the data from the tracking log, alleviating a need for manual intervention. Further, other implementations provide for the enabling of additional user roles in a system allowing additional control over data on a per-role basis without risking of the exposure of private information. Other implementations provide for identifying specific callers as bad actors when the specific callers access information beyond the intended scope of permissions. In at least one embodiment described herein, efficient sorting and clustering of database records with smarter data persistence can be achieved.

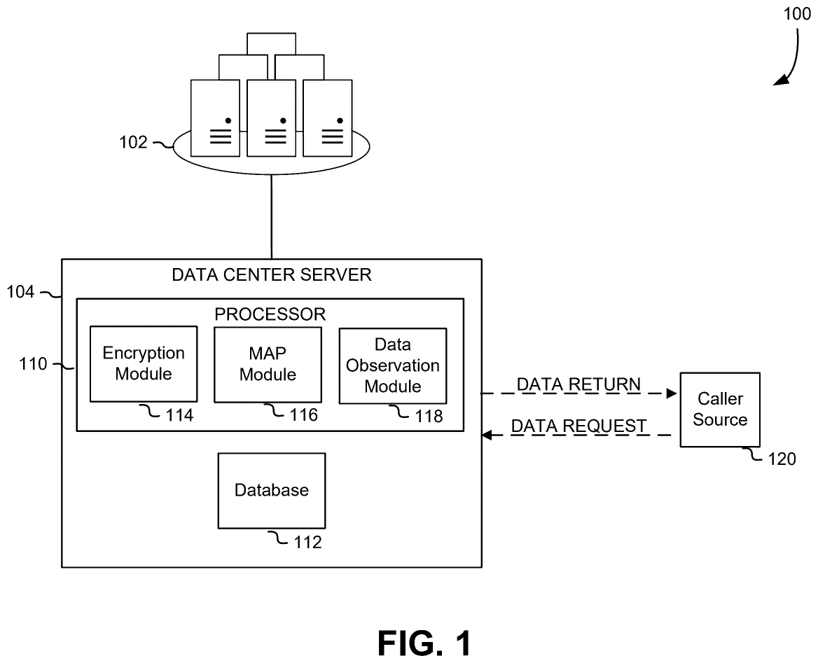

FIG. 1 illustrates a data observability system 100, according to at least one embodiment. In at least one embodiment, system 100 comprises a data center server 104 of a data center 102. Data center server 104 includes a database 112 and/or one or more processors 110 comprising modules, an encryption module 114, a module access policy (MAP) module 116, and a data observation module 118. In at least one embodiment, system 100 performs an access policy method comprising monitoring, during a monitoring period, access of a plurality of columns of a data table by a first user and a second user; generating, based on the monitoring, a log indicating, for each column of the plurality of columns of the data table, a first number of times the respective column was accessed by the first user and a second number of times the respective column was accessed by the second user; generating, based on the log and a first profile corresponding to the first user, a first access policy controlling access to each column of the plurality of columns of the data table by the first user; generating, based on the log and a second profile corresponding to the second user, a second access policy controlling access to each column of the plurality of columns of the data table by the second user; and applying the first access policy and the second access policy.

In at least one embodiment, data center server 104 of system 100 receives a request from a caller source 120 for information from database 112. Caller source 120 may be a local user, a remote user, a software process, an automation, or any source that requests information from database 112. Database 112 may, for example, comprise one or more data tables, each comprising information stored in columns and rows. In at least one embodiment, database 112 is stored in a memory, such as a non-volatile memory.

In at least one embodiment, data center server 104 comprises one or more processors 110, such as a graphics processing unit (GPU), general-purpose GPU (GPGPU), parallel processing unit (PPU), central processing unit (CPU)), a data processing unit (DPU), a part of a system on chip (SoC), or combination thereof. In at least one embodiment, processor 110 has an encryption module 114 that encrypts and/or decrypts information stored in database 112. In at least one embodiment, a caller source 120 requests data from data center server 104 contained in database 112 that has been encrypted by encryption module 114. In at least one embodiment, the requested data is decrypted using encryption module 114 and returned to caller source 120. In at least one embodiment, the encryption module performs column-level encryption in order to limit caller source 120 from accessing rows and/or columns of database 112 beyond what is necessary. In at least one embodiment, information is decrypted according to an access policy generated using MAP module 116. In at least one embodiment, by controlling encryption at a column-level, data privacy can be maintained from caller sources or bad actors.

In at least one embodiment, processor 110 additionally comprises module access policy (MAP) module 116 that generates and stores a module access policy corresponding to a caller source 120. In at least one embodiment, a module access policy defines the information (e.g., tables, columns, or rows) of database 112 that a predefined caller source 120 is able to access. In at least one embodiment, only this predefined information identified in the MAP is decrypted for output from a database that has been encrypted. In at least one embodiment, MAP module 116 generates a MAP based on information generated from data observation module 118.

In at least one embodiment, processor 110 additionally comprises data observation module 118. Data observation module 118 monitors and identifies portions of the database that are accessed by a caller source and stores information regarding the access in a data observability tracking log, according to predefined configuration information. By providing observability into database access, MAPs may be automatically generated to enable later access of predefined data portions by a caller source. Additionally, data observation module 118 may be used to identify specific callers as security risks that are accessing information beyond the intended scope of data permissions.

In at least one embodiment, the data observability tracking log is stored in a memory as an additional table in the database. In an embodiment, the tracking log is implemented as a rotated table (e.g., a table that overwrites oldest data with new data during each rotation) to control the size of the table. In another embodiment, a summary table is stored in memory as an additional table in the database in which some observed results from the tracking log are permanently stored for future reference.

In at least one embodiment, when caller source 120 requests data from an encrypted database 112, processor 116 checks for a predefined MAP generated by MAP module 116 corresponding to caller source 120. If the MAP defines that caller source 120 is permitted to access the requested data, then encryption module 114 decrypts the specific tables or columns identified in the MAP and returns that data to the caller source 120.

In at least one embodiment, a user sets a data source to be monitored and a time frame in which monitoring occurs using data observation module 118 of processor 110. During the predetermined time frame, every access to the target data source (e.g., a specific table of the database) is logged, along with the caller source that accessed it and other user-defined information.

In at least one embodiment, performing some or all of the processes of system 100 enables column-level encryption of data for tables that have complex access rules. Performing some or all of the processes of system 100 may further enable creation of additional user roles to access different portions of the database.

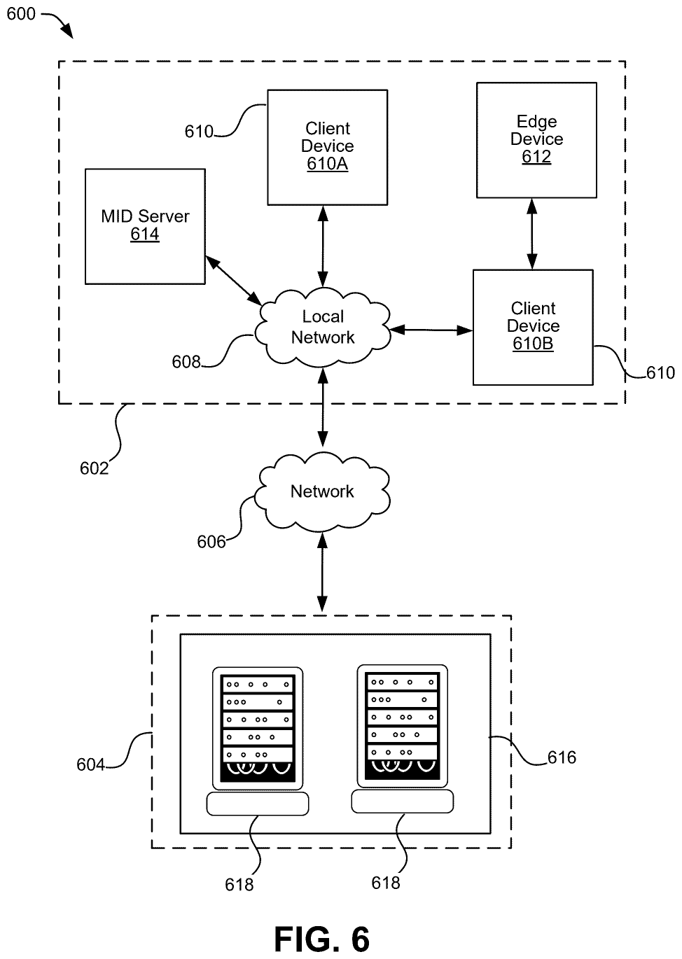

In an embodiment, some or all of the processes of system 100 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process of system 100 may be performed by any suitable system, such as the computing device 600 of FIG. 6.

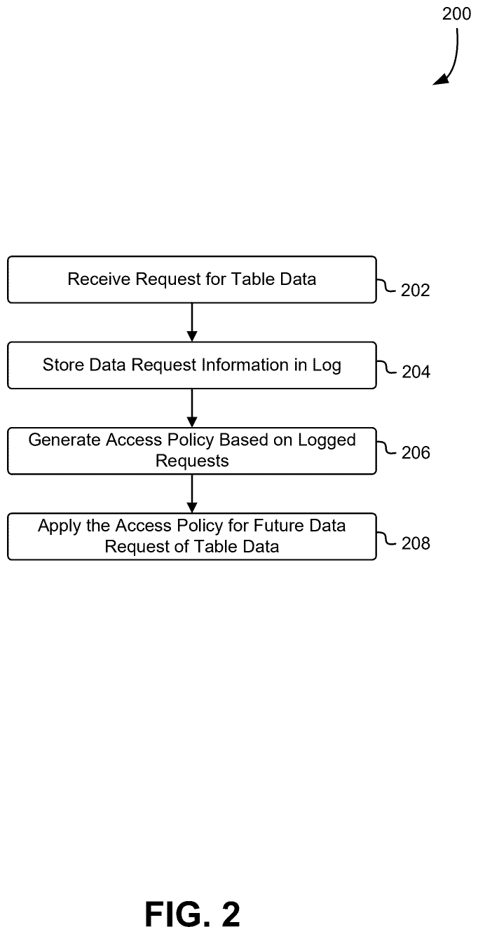

FIG. 2 illustrates a data access process 200, according to at least one embodiment. In at least one embodiment, a system such as the system described in FIG. 1 (e.g., data observability system 100 of FIG. 1) performs process 200 to monitor data access within a database from a source entity or caller. In at least one embodiment, process 200 generates an access policy for later data access based on an identified data access during a specific time period.

In at least one embodiment, at step 202, one or more caller sources (e.g., caller source 120 of FIG. 1) requests data from a table in a database (e.g., database 112 of FIG. 1). The caller sources may be monitored (e.g., using data observation module 118 of FIG. 1) to identify the data is accessed by the caller source within a given time frame. The start time and/or end time of monitoring and the tables and/or columns to be monitored may be established through a configuration option that is preset by a user or an administrator of the system.

In at least one embodiment, at step 204, data request information obtained during the monitoring period is stored in a data observability tracking log within a memory of the system. The data request information includes various information, such as caller source (e.g., human user, software process, etc.) requesting the data, the data accessed, the number of times the data is accessed per user, the permission role of the caller source, and other relevant information regarding data access. In at least one embodiment, multiple columns are monitored at the same time, with multiple callers attempting to access the multiple columns concurrently. In this example, information regarding a first caller accessing a first data column and information regarding a second caller accessing a second data column may be stored within the log.

In at least one embodiment, at step 206, a module access policy is generated (e.g., using MAP module 116) based on the data request information stored in the data observability tracking log at step 204. In at least one embodiment, a module access policy or MAP is generated to control access to one or more columns of one or more tables for caller sources (e.g., granting permission for a given caller source to access a specific column of a table). In at least one embodiment, MAPs are automatically generated for every data access identified in the data observability tracking log. In at least one embodiment, MAPs are automatically generated for data accesses that exceed a given threshold (e.g., data access more than five times.) In at least one embodiment, MAPs are automatically generated for predetermined data callers (e.g., MAP automation only for system processes.) In at least one embodiment, MAPs are manually generated by a user after displaying the log to a user. In at least one embodiment, a first MAP is generated for a first caller to access a first column of a data table, and a second MAP is generated for a second caller to access a second column of a data table.

In at least one embodiment, by performing process 200, a computing system can be enable column-level encryption of a database by ensuring that MAPs are generated for any possible caller source (e.g., at step 206/208). In at least one embodiment, by performing process 200, a computing system can log all sources that attempt to access data (e.g., at step 204) in order to identify sources that are accessing data beyond their intended access level, thereby increasing security.

In an embodiment, some or all of process 200 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 200 may be performed by any suitable system, such as the computing device 600 of FIG. 6.

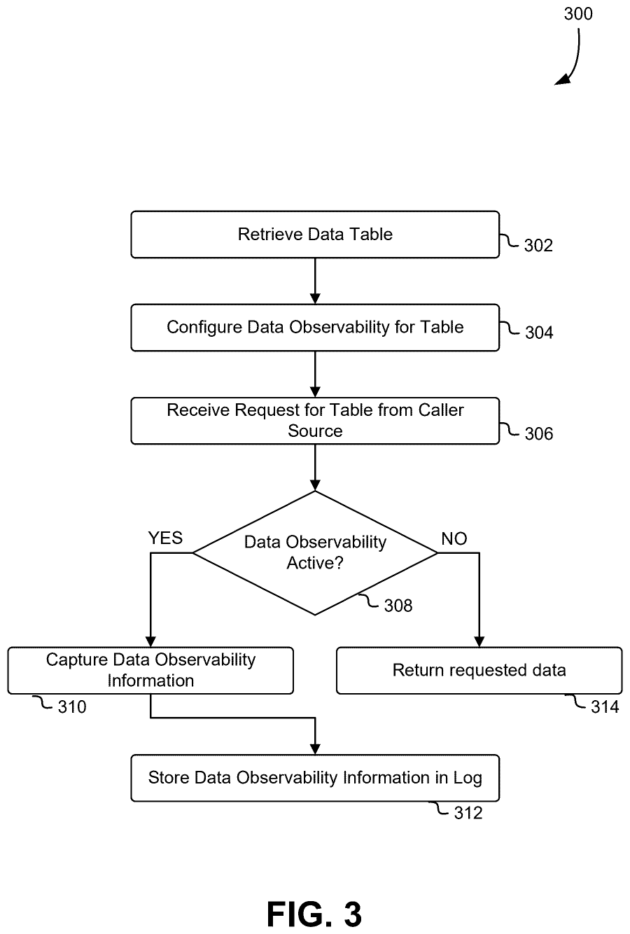

FIG. 3 illustrates a data observability process 300, according to at least one embodiment. In at least one embodiment, process 300 can be performed by the system in FIG. 1 (e.g., data observability system 100) to monitor data access within a database from a source entity or caller. In at least one embodiment, process 300 generates data observability tracking log that identifies what portions of a database have been accessed by a user or other caller source.

In at least one embodiment, at step 302, a user retrieves a table of a database (e.g., database 112 of FIG. 1) and its configuration settings. In at least one embodiment, configuration settings for the database table comprises instance configurations, data observability configurations, and other options and configurations.

In at least one embodiment, at step 304, a user or an admin of the database instance presets a data observability configuration to establish a time period in which all accesses to a predetermined column of a predetermined table are tracked and logged. In an embodiment, data observability configuration comprises parameters for an observe type (e.g., table, row, column, cell, or other data source), a table name, a table column, an active flag, and a time duration or time end.

In at least one embodiment, at step 306, at a time after the data observability configurations have been set, a caller source requests from data from a table in the database.

In at least one embodiment, at step 308, a processor (e.g., using data observability module 118 of FIG. 1) determines whether a data observability window is active. If the window is not active (NO at step 308), then no data access is added to the data observability tracking log, and the process continues to step 314 at which point the requested data is returned to the caller source, in compliance with the MAP. In at least one embodiment, if the data observability window is active (YES at step 308), then the process continued to step 312 and the requested data, table and column location, and corresponding data is added to the tracking log.

In at least one embodiment, at step 312, after information is captured during the data observability window, the captured information is stored in a data observability tracking log. The data observability tracking log may be implemented as a rotated table. The rotated table may not permanently maintain data and instead only retains information during an observation period, after which data is overwritten with new data. The data observability tracking log may be additionally supplemented with a summary table that maintains observation data permanently or for a longer period. The captured information may include all entities or caller sources that attempted to retrieve data during the window, as well as the database columns accessed.

In at least one embodiment, by performing process 300, a computing system can generate a tracking log that identifies all sources that attempt to access data (e.g., at step 306) in order to identify sources that are accessing data beyond their intended access level, thereby increasing security. In at least one embodiment, by performing process 300, a computing system can maintain a tracking log that records during specific windows (e.g., at step 308) and overwrites old data as needed, thereby reducing size constraints and computing requirements.

In at least one embodiment, implementations herein provide for the automatic creation of a MAP based on the data from the data observability tracking log. In an embodiment, the process 300 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 300 may be performed by any suitable system, such as the computing device 600 of FIG. 6. In at least one embodiment, performing process 200 of FIG. 2 and by performing process 300, efficient sorting and clustering of database records with smarter data persistence can be achieved.

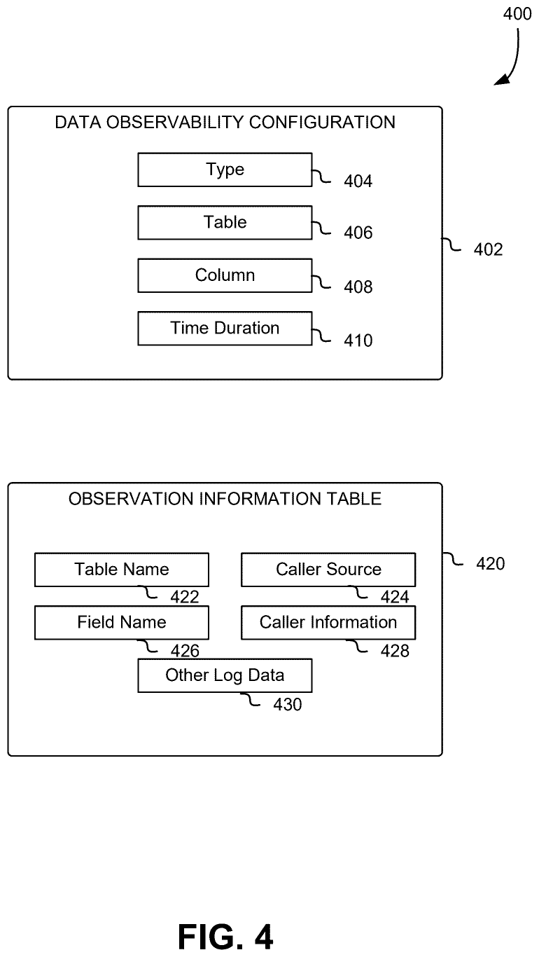

FIG. 4 illustrates an example data observability configuration screen and an observation information table 400, according to at least one embodiment. In at least one embodiment, a system, such as the system described in FIG. 1 (e.g., data observability system 100 of FIG. 1), uses a configuration menu screen and an observation information table, such as shown in 400.

In at least one embodiment, a data observability configuration menu 402 contains various options that control a data observability window in a data observability system (e.g., system 100 of FIG. 1). The data observability window may include an observe type 404 (e.g., table, row, column, cell, or other data source), a table name 406, a table column 408, and a time duration or time end 410. The data observability window may additionally include an active flag or Boolean that indicates whether the data observability window is currently active.

In at least one embodiment, by setting the data observability configuration menu 402, an administrator of a system (e.g., system 100 of FIG. 1) can establish a time window in which table access is monitored and identify every entity or caller source and the information accessed by the entity during the time window.

In at least one embodiment, all caller sources (e.g., caller source 120 of FIG. 1) that request data from a monitored table within a data observability window are stored in an observation information table 420. The observation information table 420 may contain various information corresponding to the caller sources and the requested active within the observability window. The observation information table 420 may include information such as the monitored table name 422, monitored field name 426 (e.g., column or row), caller source 424 (e.g., user id or computer process requesting the data), caller information 428 (e.g., additional information corresponding the user, user role, application, or process), and/or other log data 430 pertinent to the tracking log (e.g., session ID, system ID, software stack information.)

In at least one embodiment, the observation information table 420 may be a large table because it is generally expected that there are many caller sources requesting data at any given time. In order to prevent the data observability tracking log from becoming too large, the observation information table 420 may be implemented as a rotated table that overwrites itself during each data rotation. In at least one embodiment, the observation information table 420 is stored as an additional table in the database volume.

In an embodiment, some or all of the configuration settings or tables of FIG. 4 (or any other processes described such as process 200 of FIG. 2, process 300 of FIG. 3, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, the configuration windows and tables of FIG. 4 may be performed by any suitable system, such as the computing device 600 of FIG. 6.

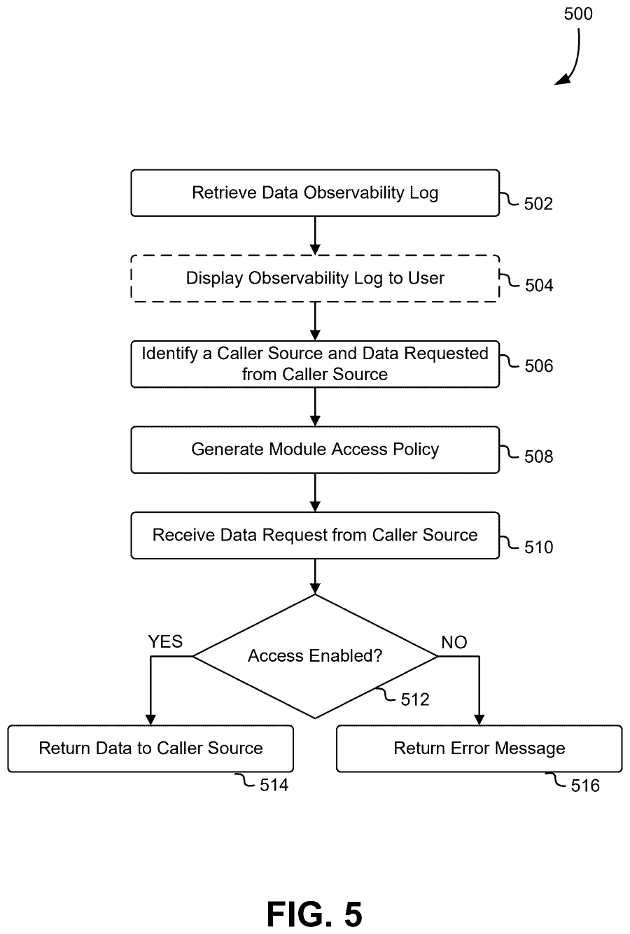

FIG. 5 illustrates a module access policy generation process 500. In at least one embodiment, process 500 can be performed by the system in FIG. 1 (e.g., data observability system 100) to generate a module access policy (MAP). In at least one embodiment, a processor (e.g., processor 120 or 130 of FIG. 1) performs processes 500 to enable column-level encryption of a database.

In at least one embodiment, at step 502, a processor (e.g., processor 110 of FIG. 1) uses a module (e.g., using MAP module 116) to retrieve a tracking log information (e.g., generated by data observation module 118) stored in an observation information table (e.g., table 420 of FIG. 4). The tracking log information may comprise information such as the monitored table name 422, monitored field name 426 (e.g., column or row), caller source 424 (e.g., user id or computer process requesting the data), caller information 428 (e.g., additional information corresponding the user, user role, application, or process), and/or other log data 430 pertinent to the tracking log (e.g., session ID, system ID, software stack information.)

In at least one embodiment, at step 504, the observability tracking log generated by a data observation module may be optionally provided to a user for review. A user or administrator of the system may review the data obtained in the data observability tracking log to identify unknown caller sources accessing data or caller sources accessing data beyond their intended permissions or to identify which data accesses should be made into a module access policy.

In at least one embodiment, at step 506, each caller source captured during an access monitoring window is identified along with the data requested by the caller source from the data observability tracking log. The number of times data columns are accessed by caller sources are aggregated and counted to identify the portions of the database that are most often accessed by the caller sources.

In at least one embodiment, at step 508, a processor may automatically generate or a user may manually generate a module access policy in order to permit a caller source later access to a specific column of a table based on the information gathered in the data observability tracking log. In at least one embodiment, automatic generation of a MAP is created for every data access identified in the data observability tracking log, created for data accesses that exceed a given threshold (e.g., data access more than five times) as counted at step 506, or created for predetermined specific caller sources (e.g., MAP automation only for system processes.)

In at least one embodiment, at a future time after a module access policy is generated from step 508, a caller source requests data from the database at step 510. A processor of the data observability system 100 may then retrieve the module access policies that correspond to the caller source.

In at least one embodiment, at step 512, a processor determines whether access to the caller source is permitted to the requested data by identifying whether the request matches a module access policy. If the module access policy permits access to the requested data (YES at step 512), then the system may return the requested data to the caller source at step 514. Conversely, if the module access policy does not permit access to the requested data, then the system may return an error message to the caller source at step 516 indicating that the data cannot be retrieved.

In at least one embodiment, by performing process 500, a computing system can be enable column-level encryption of a database by ensuring that MAPs are generated for any possible caller source (e.g., at step 508). In at least one embodiment, by performing process 500, a computing system can enable access to a given database entry to a caller source that has been previously identified (e.g., at step 514) because a MAP has already been created for it, increasing usability of the system.

In an embodiment, some or all of process 500 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 500 may be performed by any suitable system, such as the computing device 600 of FIG. 6.

FIG. 6 illustrates a system 600 in which various embodiments can be implemented. The system 600 may include a client network 602 and a provider platform 604 that are operably connected via a network 606 (e.g., the Internet). In an embodiment, the client network 602 may be a private local network 608, such as a local area network (LAN) that includes a variety of network devices that include, but are not limited to, switches, servers, and routers. In an embodiment, the client network 602 can comprise an enterprise network that can include one or more LANs, virtual networks, data centers, and/or other remote networks. In an embodiment, the client network 602 can be operably connected to one or more client devices 610 such as example client device 610A, 610B so that the client devices 610 are able to communicate with each other and/or with the provider platform 604. In an embodiment, the client devices 610 can be computing systems and/or other types of computing devices generally referred to as Internet of Things (IoT) devices that can access cloud computing services, for example, via a web browser application or via an edge device 612 that may act as a gateway between one or more client devices 610 and the platform 604 (e.g., second client device 610B). In an embodiment, the client network 602 can include a management, instrumentation, and discovery (MID) server 614 that facilitates communication of data between the network hosting the platform 604, other external applications, data sources, and services, and the client network 602. In an embodiment, the client network 602 may also include a connecting network device (e.g., a gateway or router) or a combination of devices that implement a customer firewall or intrusion protection system.

In an embodiment, the client network 602 can be operably coupled to the network 606, which may include one or more suitable computing networks, such a large area network (LAN), wide area networks (WAN), the Internet, and/or other remote networks, that are operable to transfer data between the client devices 610 and the provider platform 604. In an embodiment, one or more computing networks within network 606 can comprise wired and/or wireless programmable devices that operate in the electrical and/or optical domain. For example, network 606 may include wireless networks, such as cellular networks (e.g., Global System for Mobile Communications (GSM) based cellular network), WIN networks, and/or other suitable radio-based networks. The network 606 may also employ any suitable network communication protocols, such as Transmission Control Protocol (TCP), Internet Protocol (IP), and the like. In an embodiment, network 606 may include a variety of network devices, such as servers, routers, network switches, and/or other suitable network hardware devices configured to transport data over the network 606.

In an embodiment, the provider platform 604 may be a remote network (e.g., a cloud network) that is able to communicate with the client devices 610 via the client network 602 and network 606. In an embodiment, the provider platform 604 can comprise a configuration management database (CMDB) platform. In an embodiment, the provider platform 604 provides additional computing resources to the client devices 610 and/or the client network 602. For example, by utilizing the provider platform 604, in some examples, users of the client devices 610 can build and execute applications for various enterprise, IT, and/or other organization-related functions. In one embodiment, the provider platform 604 can be implemented on the one or more data centers 616, where each data center 616 can correspond to a different geographic location in some examples. In an embodiment, one or more the data centers 616 includes a plurality of servers 618 (also referred to in some examples as application nodes, virtual servers, application servers, virtual server instances, application instances, application server instances, or the like), where each server 618 can be implemented on a physical computing system, such as a single electronic computing device (e.g., a single physical hardware server) or across multiple-computing devices (e.g., multiple physical hardware servers). Examples of servers 618 can include a virtual server, a web server (e.g., a unitary Apache installation), an application server (e.g., a unitary Java Virtual Computer), and/or a database server.

To utilize computing resources within the provider platform 604, in an embodiment, network operators may choose to configure the data centers 616 using a variety of computing infrastructures. In an embodiment, one or more of the data centers 616 can be configured using a multi-instance cloud architecture to provide every customer with its own unique customer instance or instances. For example, a multi-instance cloud architecture of some embodiments can provide each customer instance with its own dedicated application server and dedicated database server. In some examples, the multi-instance cloud architecture could deploy a single physical or virtual server 618 and/or other combinations of physical and/or virtual servers 618, such as one or more dedicated web servers, one or more dedicated application servers, and one or more database servers, for each customer instance. In an embodiment of a multi-instance cloud architecture, multiple customer instances can be installed on one or more respective hardware servers, where each customer instance is allocated certain portions of the physical server resources, such as computing memory, storage, and processing power. By doing so, in some examples each customer instance has its own unique software stack that provides the benefit of data isolation, relatively less downtime for customers to access the platform 604, and customer-driven upgrade schedules.

In some embodiments, the provider platform 604 includes a computer-generated data management server that receives, via network 606 and/or an internal network within or across different data centers, computer-generated data for storage and analysis. For example, log entries can be sent from client devices/servers 610, MID server 614 (e.g., agent server acting as the intermediary in client network 602 to facilitate access to client network 602 by the network hosting the platform 604), and/or servers in data centers 616 to a log management server in data centers 616.

Although FIG. 6 illustrates a specific embodiment of a cloud computing system 600, the disclosure is not limited to the specific embodiments illustrated in FIG. 6. For instance, although FIG. 6 illustrates that the platform 604 is implemented using data centers, other embodiments of the platform 604 are not limited to data centers and can utilize other types of remote network infrastructures. Some embodiments may combine one or more different virtual servers into a single virtual server. The use and discussion of FIG. 6 are only examples to facilitate ease of description and explanation and are not intended to limit the disclosure to the specific examples illustrated therein. In an embodiment, the respective architectures and frameworks discussed with respect to FIG. 6 can incorporate suitable computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UPnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

One aspect of the disclosure includes a method for identifying data access in a data table and generating an access policy to the data table. The method may include monitoring, during a monitoring period, access of a plurality of columns of a data table by a first user and a second user. The method may further include generating, based on the monitoring, a log indicating, for each column of the plurality of columns of the data table, a first number of times the respective column was accessed by the first user and a second number of times the respective column was accessed by the second user. The method may further include generating, based on the log and a first profile corresponding to the first user, a first access policy controlling access to each column of the plurality of columns of the data table by the first user. The method may further include generating, based on the log and a second profile corresponding to the second user, a second access policy controlling access to each column of the plurality of columns of the data table by the second user. The method may further include applying the first access policy and the second access policy.

Implementations of the disclosure may include one or more of the following features. The method may include, wherein monitoring access of the plurality of columns of the data table by the first user and the second user comprises, for each column of the plurality of columns, counting the first number of times the respective column is accessed by the first user and counting the second number of times the respective column is accessed by the second user. The method may indicate that the first access policy is different from the second access policy. The method may further indicate the first access policy is the same as the second access policy. The method may further include monitoring, during a second monitoring period, a change in access of the plurality of columns of the data table by the first user and the second user, generating, based on the second monitoring period, a second log, and modifying, based on the second log, the first access policy and the second access policy. The method may additionally indicate that a duration of the monitoring period is predefined according to a data observability configuration setting. The method may further indicate the log comprises a rotated table. The method may further include decrypting one or more encrypted columns of the data table requested by the first user based on the applied first access policy. The method may further include decrypting one or more encrypted columns of the data table requested by the second user based on the applied second access policy. The method may further include returning an error message to the first user when the first access policy does not permit access to the plurality of columns in the data table.

Another aspect of the disclosure includes a system comprising one or more processors and a memory including computer-executable instructions. The one or more processors, when executing the computer-executable instructions, may cause the system to monitor, during a monitoring period, access of a plurality of columns of a data table by a first user and a second user. The one or more processors may further cause the system to generate, based on the monitoring, a log indicating, for each column of the plurality of columns of the data table, a first number of times the respective column was accessed by the first user and a second number of times the respective column was accessed by the second user. The one or more processors may further cause the system to generate, based on the log and a first profile corresponding to the first user, a first access policy controlling access to each column of the plurality of columns of the data table by the first user. The one or more processors may further cause the system to generate, based on the log and a second profile corresponding to the second user, a second access policy controlling access to each column of the plurality of columns of the data table by the second user. The one or more processors may further cause the system to apply the first access policy and the second access policy.

Implementations of the disclosure may include one or more of the following features. The one or more processors may further cause the system to include wherein monitoring access of the plurality of columns of the data table by the first user and the second user comprises, for each column of the plurality of columns, counting the first number of times the respective column is accessed by the first user and counting the second number of times the respective column is accessed by the second user. The one or more processors may further cause the system to indicate that the first access policy is different from the second access policy. The one or more processors may further cause the system to indicate the first access policy is the same as the second access policy. The one or more processors may further cause the system to monitor, during a second monitoring period, a change in access of the plurality of columns of the data table by the first user and the second user, generate, based on the second monitoring period, a second log, and modify, based on the second log, the first access policy and the second access policy. The one or more processors may further cause the system to indicate that a duration of the monitoring period is predefined according to a data observability configuration setting. The one or more processors may further cause the system to indicate the log comprises a rotated table. The one or more processors may further cause the system to decrypt one or more encrypted columns of the data table requested by the first user based on the applied first access policy. The one or more processors may further cause the system to decrypt one or more encrypted columns of the data table requested by the second user based on the applied second access policy. The one or more processors may further cause the system to return an error message to the first user when the first access policy does not permit access to the plurality of columns in the data table.

Another aspect of the disclosure includes a non-transitory computer-readable storage medium having stored thereon executable instructions that are executable by one or more processors of a computer system. The computer-readable storage medium may include instructions to monitor, during a monitoring period, access of a plurality of columns of a data table by a first user and a second user. The computer-readable storage medium may further include instructions to generate, based on the monitoring, a log indicating, for each column of the plurality of columns of the data table, a first number of times the respective column was accessed by the first user and a second number of times the respective column was accessed by the second user. The computer-readable storage medium may further include instructions to generate, based on the log and a first profile corresponding to the first user, a first access policy controlling access to each column of the plurality of columns of the data table by the first user. The computer-readable storage medium may further include instructions to generate, based on the log and a second profile corresponding to the second user, a second access policy controlling access to each column of the plurality of columns of the data table by the second user. The computer-readable storage medium may further include instructions to apply the first access policy and the second access policy.

Implementations of the disclosure may additionally include one or more of the following features. The computer-readable storage medium may further include instructions that cause the computer system to indicate wherein to monitor access of the plurality of columns of the data table by the first user and the second user comprises, for each column of the plurality of columns, counting the first number of times the respective column is accessed by the first user and counting the second number of times the respective column is accessed by the second user. The computer-readable storage medium may further include instructions that cause the computer system to indicate that the first access policy is different from the second access policy. The computer-readable storage medium may further include instructions that cause the computer system to indicate the first access policy is the same as the second access policy. The computer-readable storage medium may further include instructions that cause the computer system to monitor, during a second monitoring period, a change in access of the plurality of columns of the data table by the first user and the second user, generate, based on the second monitoring period, a second log, and modify, based on the second log, the first access policy and the second access policy. The computer-readable storage medium may further include instructions that cause the computer system to indicate that a duration of the monitoring period is predefined according to a data observability configuration setting. The computer-readable storage medium may further include instructions that cause the computer system to indicate the log comprises a rotated table. The computer-readable storage medium may further include instructions that cause the computer system to decrypt one or more encrypted columns of the data table requested by the first user based on the applied first access policy. The computer-readable storage medium may further include instructions that cause the computer system to decrypt one or more encrypted columns of the data table requested by the second user based on the applied second access policy. The computer-readable storage medium may further include instructions that cause the computer system to return an error message to the first user when the first access policy does not permit access to the plurality of columns in the data table.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—For example, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A method, comprising:
monitoring, during a monitoring period, access of a plurality of columns of a data table by a first user and a second user;
generating, based on the monitoring, a log indicating:
for each column of the plurality of columns of the data table:
a first number of times the respective column was accessed by the first user;
a second number of times the respective column was accessed by the second user;
generating, based on the log and a first profile corresponding to the first user, a first access policy controlling access to each column of the plurality of columns of the data table by the first user;
generating, based on the log and a second profile corresponding to the second user, a second access policy controlling access to each column of the plurality of columns of the data table by the second user; and
applying the first access policy and the second access policy.

2. The method of claim 1, wherein monitoring access of the plurality of columns of the data table by the first user and the second user comprises:
for each column of the plurality of columns:
counting the first number of times the respective column is accessed by the first user; and
counting the second number of times the respective column is accessed by the second user.

3. The method of claim 1, wherein the first access policy is different from the second access policy.

4. The method of claim 1, wherein the first access policy is the same as the second access policy.

5. The method of claim 1, further comprising:
monitoring, during a second monitoring period, a change in access of the plurality of columns of the data table by the first user and the second user;
generating, based on the second monitoring period, a second log; and
modifying, based on the second log, the first access policy and the second access policy.

6. The method of claim 1, wherein a duration of the monitoring period is predefined according to a data observability configuration setting.

7. The method of claim 1, wherein the log comprises a rotated table.

8. A system, comprising:
one or more processors; and
memory including computer-executable instructions that, if executed by the one or more processors, cause the system to:
monitor, during a monitoring period, access of a plurality of columns of a data table by a first user and a second user;
generate, based on the monitoring, a log indicating:
for each column of the plurality of columns of the data table:
a first number of times the respective column was accessed by the first user;
a second number of times the respective column was accessed by the second user;
generate, based on the log and a first profile corresponding to the first user, a first access policy controlling access to each column of the plurality of columns of the data table by the first user;
generate, based on the log and a second profile corresponding to the second user, a second access policy controlling access to each column of the plurality of columns of the data table by the second user; and
apply the first access policy and the second access policy.

9. The system of claim 8, wherein the system monitors access of the plurality of columns of the data table by the first user and the second user comprising:
for each column of the plurality of columns:
counting the first number of times the respective column is accessed by the first user; and
counting the second number of times the respective column is accessed by the second user.

10. The system of claim 8, wherein the first access policy is different from the second access policy.

11. The system of claim 8, wherein the first access policy is the same as the second access policy.

12. The system of claim 8, wherein the one or more processors further cause the system to:
monitor, during a second monitoring period, a change in access of the plurality of columns of the data table by the first user and the second user;
generate, based on the second monitoring period, a second log; and
modify, based on the second log, the first access policy and the second access policy.

13. The system of claim 8, wherein the one or more processors further cause the system to:
decrypt one or more encrypted columns of the data table requested by the first user based on the applied first access policy.

14. The system of claim 8, wherein the one or more processors further cause the system to:
decrypt one or more encrypted columns of the data table requested by the second user based on the applied second access policy.

15. A non-transitory computer-readable storage medium having stored thereon executable instructions which, when executed by one or more processors of a computer system, cause the computer system to:
monitor, during a monitoring period, access of a plurality of columns of a data table by a first user and a second user;
generate, based on the monitoring, a log indicating:
for each column of the plurality of columns of the data table:
a first number of times the respective column was accessed by the first user;
a second number of times the respective column was accessed by the second user;
generate, based on the log and a first profile corresponding to the first user, a first access policy controlling access to each column of the plurality of columns of the data table by the first user;
generate, based on the log and a second profile corresponding to the second user, a second access policy controlling access to each column of the plurality of columns of the data table by the second user; and
apply the first access policy and the second access policy.

16. The non-transitory computer-readable storage medium of claim 15, wherein the one or more processors monitor access of the plurality of columns of the data table by the first user and the second user comprising:
for each column of the plurality of columns:
counting the first number of times the respective column is accessed by the first user; and
counting the second number of times the respective column is accessed by the second user.

17. The non-transitory computer-readable storage medium of claim 15, wherein the first access policy is different from the second access policy.

18. The non-transitory computer-readable storage medium of claim 15, wherein the first access policy is the same as the second access policy.

19. The non-transitory computer-readable storage medium of claim 15, wherein the one or more processors further cause the system to:
monitor, during a second monitoring period, a change in access of the plurality of columns of the data table by the first user and the second user;
generate, based on the second monitoring period, a second log; and
modify, based on the second log, the first access policy and the second access policy.

20. The non-transitory computer-readable storage medium of claim 15, wherein the one or more processors further cause the computer system to:
return an error message to the first user when the first access policy does not permit access to the plurality of columns in the data table.
